(19) United States
(12) Patent Application Publication
(10) Pub. No.: US 2020/0264845 A1
(43) Pub. Date: Aug. 20, 2020

(54) SYSTEM AND METHOD FOR GENERATING INTERLINKED VIEWS OF A SEMANTIC MODEL OVER A DRAWING CANVAS

(71) Applicant: HCL TECHNOLOGIES LIMITED, Uttar Pradesh (IN)

(72) Inventors: Sandeep KATOCH, Frisco, TX (US); Sreenivasulu VALMETI, Bangalore (IN); Badrinarayan RAVICHANDRAN, Bangalore (IN)

(21) Appl. No.: 16/279,597

(22) Filed: Feb. 19, 2019

(51) Int. Cl. G06F 8/20; G06F 16/23

(52) U.S. Cl. CPC G06F 8/20; G06F 3/0481; G06F 16/2379

(57) ABSTRACT

The present disclosure relates to system(s) and method(s) for generating interlinked views of a semantic model over a drawing canvas. The system is configured for maintaining a set of views and correlation information over a database. The system is further configured for receiving the user inputs to update a target model element of a target view from the set of views and identify a subset of views, from the set of views, associated with the target view based on the target model element and the correlation information. The system is further configured for updating, the target view and the subset of views based on the user inputs to update a target model element. The system is further configured for displaying the updated target view and the updated subset of views over the drawing canvas thereby generating interlinked views of a semantic model.

### CROSS-REFERENCE TO RELATED APPLICATIONS AND PRIORITY

The present application does not claim priority from any patent application.

### TECHNICAL FIELD

The present disclosure in general relates to the field of semantic modelling. More particularly, the present disclosure relates to a system and method for generating interlinked views of a semantic model over a single drawing canvas.

### BACKGROUND

UML (Unified modelling language) is a systematic approach for software development. In recent times, UML has gained a lot of importance in the process of software development lifecycle. UML is basically related to diagrammatic representations of software under development. The diagrammatic representations enables the software development team to understand possible flaws or errors in software under development. UML model have different views on top of a semantic model and these views exist on specific diagrams. For example, a Class Diagram contains views of UML Classes whereas an Activity Diagram contains views of UML Activity elements.

However, UML modelling tools, which support an underlying semantic model have some restrictions. For example, in the Class view, only Class elements can be shown and interlinked. However, the Class elements cannot be interlinked with Activity elements or any other elements of other views in the same diagram. Furthermore, in the non-UML/Modeling tools, if the user wishes to make some changes in a target view, similar changes would not be updated automatically in the subset views drawn on the single canvas. Hence, no technology exists to enable the above-mentioned problems. Thus, there is need of a system to overcome the problems and yield the optimum result.

### SUMMARY

Before the present systems and method for generating interlinked views of a semantic model over a drawing canvas is illustrated. It is to be understood that this application is not limited to the particular systems and methodologies described, as there can be multiple possible embodiments that are not expressly illustrated in the present disclosure. It is also to be understood that the terminology used in the description is for the purpose of describing the particular versions or embodiments only, and is not intended to limit the scope of the present application. This summary is provided to introduce concepts related to systems and method for generating interlinked views of a semantic model over a drawing canvas. This summary is not intended to identify essential features of the claimed subject matter nor is it intended for use in determining or limiting the scope of the claimed subject matter.

In one implementation, a system for generating interlinked views of a semantic model over a drawing canvas is illustrated. The system comprises a memory and a processor coupled to the memory, wherein the processor is configured to execute programmed instructions stored in the memory to maintain a set of views and correlation information over a database. The set of views are generated over a drawing canvas based on user inputs. In one embodiment, each view comprises a set of model elements. Further, the correlation information corresponds to dependencies between one or more model elements of each view, over one or more model elements of other views from the set of views. Further, the processor is configured to execute programmed instructions stored in the memory to receive user inputs to update a target model element of a target view from the set of views. Further, the processor is configured to execute programmed instructions stored in the memory to identify a subset of views, from the set of views, associated with the target view based on the target model element and the correlation information. Further, the processor is configured to execute programmed instructions stored in the memory to update the target view and the subset of views based on the user inputs to update a target model element. Further, the processor is configured to execute programmed instructions stored in the memory to display the updated target view and the updated subset of views over the drawing canvas thereby generating interlinked views of a semantic model.

In one implementation, a method for generating interlinked views of a semantic model over a drawing canvas is illustrated. The method may comprise steps for maintaining a set of views and correlation information over a database. The set of views are generated over a drawing canvas based on user inputs. In one embodiment the correlation information corresponds to dependencies between one or more model elements of each view, over one or more model elements of other views from the set of views. The method may further comprise steps for receiving the user inputs to update a target model element of a target view from the set of views. The method may further comprise steps for identifying a subset of views, from the set of views, associated with the target view based on the target model element and the correlation information. The method may further comprise steps for updating the target view and the subset of views based on the user inputs to update a target model element. The method may further comprise steps for displaying the updated target view and the updated subset of views over the drawing canvas thereby generating interlinked views of a semantic model.

In yet another implementation, a computer program product having embodied computer program for generating interlinked views of a semantic model over a drawing canvas is disclosed. The program may comprise a program code to maintain a set of views and correlation information over a database. The set of views are generated over a drawing canvas based on user inputs, wherein each view comprises a set of model elements, and wherein the correlation information corresponds to dependencies between one or more model elements of each view, over one or more model elements of other views from the set of views. The program may comprise a program code to receive the user inputs to update a target model element of a target view from the set of views. The program may comprise a program code to identify a subset of views, from the set of views, associated with the target view based on the target model element and the correlation information. The program may comprise a program code to update the target view and the subset of views based on the user inputs to update a target model element. The program may comprise a program code to display the updated target view and the updated subset of views over the drawing canvas thereby generating interlinked views of a semantic model.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system configured for generating interlinked views of a semantic model over a drawing canvas, in accordance with an embodiment of the present subject matter.

FIG. 2 illustrates the system configured for generating interlinked views of a semantic model over a drawing canvas, in accordance with an embodiment of the present subject matter.

FIG. 3 illustrates a method for generating interlinked views of a semantic model over a drawing canvas, in accordance with an embodiment of the present subject matter.

### DETAILED DESCRIPTION

Some embodiments of the present disclosure illustrating all its features will now be discussed in detail. The words “maintaining”, “receiving”, “identifying”, “updating”, “displaying” and other forms thereof are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an” and “the” include plural references unless the context clearly dictates otherwise. Although any systems and methods similar or equivalent to those described herein can be used for generating interlinked views of a semantic model over a drawing canvas, the exemplary, systems and method for pre-processing of the image is now described.

Various modifications to the embodiment will be readily apparent to those skilled in the art and the generic principles herein may be applied to other embodiments. However, one of ordinary skill in the art will readily recognize that the present disclosure for generating interlinked views of a semantic model over a drawing canvas is not intended to be limited to the embodiments illustrated, but is to be accorded the widest scope consistent with the principles and features described herein.

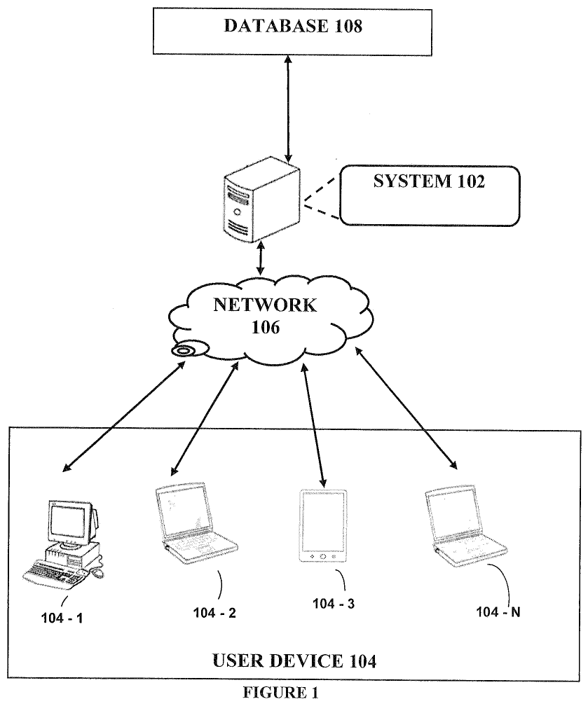

In one embodiment, the system may be configured to maintain a set of views and correlation information over a database. The system may allow all kinds of views to be generated and placed on a single drawing canvas. Further, the system is configured to generate set of views and correlation information. It is to be noted that, the user inputs received from the user device generates the set of views. In one embodiment, the correlation information may correspond to dependencies between one or more model elements of each view, over one or more model elements of other views from the set of views. Based on the correlation information, the system may interlink all the views of the semantic model over the canvas. For example, if the user makes some changes in a target view by changing one of its properties of the target element in the target view for e.g. name of the target element, colour of the target element and the like, then the system is configured to automatically update other inter-linked views present on the same canvas. Further, the network implementation of system configured for generating interlinked views of a semantic model over a drawing canvas is illustrated with reference to FIG. 1.

Referring now to FIG. 1, a network implementation 100 of a system 102 for generating interlinked views of a semantic model over a drawing canvas is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented over a server. Further, the system 102 may be implemented in a cloud network. In one embodiment, the system may be implemented as a Platform as a Service (Paas). The system 102 may further be configured to communicate with database 108.

Further, it will be understood that multiple users may access the system 102 through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a network 106.

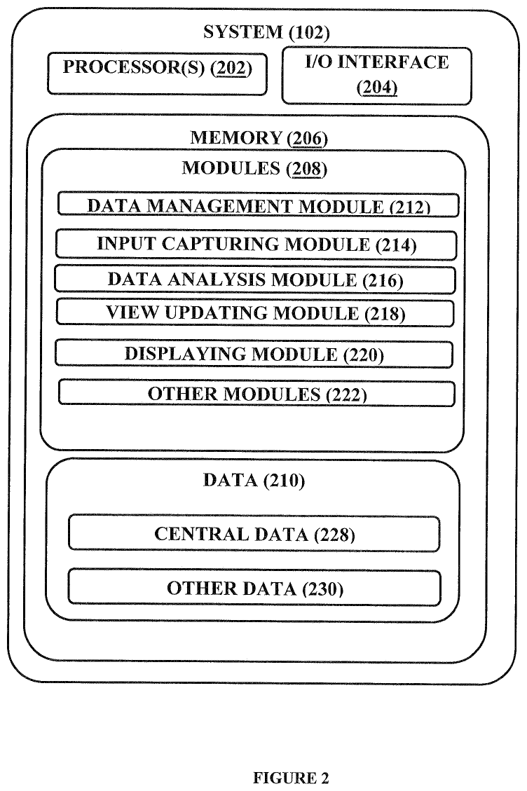

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Hypertext Transfer Protocol Secure (HTTPS), File Transfer Protocol (FTP), Transmission Control Protocol/Internet Protocol (TCP/IP), Wireless Application Protocol (WAP) and the like to communicate with one another. Further, the network 106 may include a variety of network devices, including routers, bridges, servers, computing devices, storage devices, and the like. In one embodiment, the system 102 may be configured to receive data or stores the set of views over the database 108. Further, the system 102 configured to process the data stored over the database 108 is described with respect to FIG. 2.

Referring now to FIG. 2, the system 102 configured for generating interlinked views of a semantic model over a drawing canvas in accordance with an embodiment of the present subject matter is illustrated. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the modules 208 may be configured to perform functions of the speech controller, visual face recognition & controller, and modulation and frame decomposer. The modules 208 may include a data management module 212, an input capturing module 214, a data analysis module 216, a view updating module 218, a displaying module 220, and other modules 222. The other modules 222 may include programs or coded instructions that supplement applications and functions of the system 102.

The data 210, amongst other things, serve as a repository for storing data processed, received, and generated by one or more of the modules 208. The data 210 may also include a central data 228, and other data 230. In one embodiment, the other data 230 may include data generated as a result of the execution of one or more modules in the other modules 222. In one implementation, a user may access the system 102 via the I/O interface 204. The user may be registered using the I/O interface 204 in order to use the system 102. In one aspect, the user may access the I/O interface 204 of the system 102 for obtaining information, providing input information or configuring the system 102. The functioning of all the modules in the system 102 is described as below:

### Data Management Module 212

In one embodiment, the data management module 212 is configured to maintain a set of views. The set of views may include class view, activity view, use case view, object view and the like. Further, the module is also configured to maintain correlation information associated with the set of views. The correlation information relates to the dependencies between one or more views from the set of views. The set of views may be generated over the drawing canvas based on user inputs. The drawing canvas may be associate with a UML tool installed over the system 102. Further, the drawing canvas may display a set of model elements associated with each view from the set of views. A user may pick and place one or more model element on the drawing canvas in order to generate the set of views. Further, the data management module 212 also captures the correlation information associated with the set of views. Once the set of views and the correlation information is captured, this information is stored over the database 108.

### Input Capturing Module 214

In one embodiment, the input capturing module 214 is configured to accept the user inputs from the user device 104 for updating a target model element for a target view. The target view is selected from the set of views displayed on the drawing canvas. The user device 104 may include but not limited to, a portable computer, a personal digital assistant, a handheld device, and a workstation. In one embodiment, the view on which the user is currently working may be referred to as the target view. The “user inputs” is analogous to insertion of the model elements on the target view. The target view may be one of a class view, an activity view and the like. Further, the updates on the target model may correspond to changes in a target model present in the target view.

### Data Analysis Module 216

In one embodiment, the data analysis module 216 is configured to identify a subset of views from the set of views displayed on the drawing canvas. The subset of views are associated with the target model element in the target view. The subset of views associated with the target model element may be identified based on the correlation information. The correlation information is the information of dependencies between the model elements of the each view with one or more other views from the set of views.

### View Updating Module 218

In one embodiment, the view updating module 218 is configured to update the target view and the subset of views based on the user inputs. For example, if the user make some changes in the target view, the subset views are automatically updated on the drawing canvas. As a result, the user does not have to manually update each view based on the changes in the target view.

### Displaying Module 220

Finally, the displaying module 220 is configured to display the updated subset of views and the target view on the drawing canvas. In one embodiment, changes proposed in the target view are automatically reflected in the subset of views in real-time.

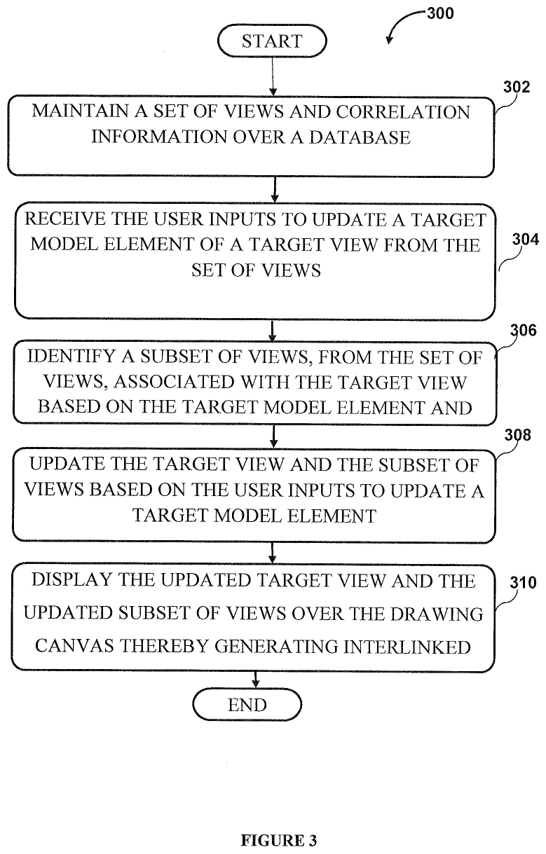

Referring now to FIG. 3, a method 300 for generating interlinked views of a semantic model over a drawing canvas, is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, the data management module 212 is configured to maintain a set of views. The set of views may include class view, activity view, use case view, object view and the like. Further, the module is also configured to maintain correlation information associated with the set of views. The correlation information relates to the dependencies between one or more views from the set of views. The set of views may be generated over the drawing canvas based on user inputs. The drawing canvas may be associate with a UML tool installed over the system 102. Further, the drawing canvas may display a set of model elements associated with each view from the set of views. A user may pick and place one or more model element on the drawing canvas in order to generate the set of views. Further, the data management module 212 also captures the correlation information associated with the set of views. Once the set of views and the correlation information is captured, this information is stored over the database 108.

At block 304, the input capturing module 214 is configured to accept the user inputs from the user device 104 for updating a target model element for a target view. The target view is selected from the set of views displayed on the drawing canvas. The user device 104 may include but not limited to, a portable computer, a personal digital assistant, a handheld device, and a workstation. In one embodiment, the view on which the user is currently working may be referred to as the target view. The “user inputs” is analogous to insertion of the model elements on the target view. The target view may be one of a class view, an activity view and the like. Further, the updates on the target model may correspond to changes in a target model present in the target view.

At block 306, the data analysis module 216 is configured to identify a subset of views from the set of views displayed on the drawing canvas. The subset of views are associated with the target model element in the target view. The subset of views associated with the target model element may be identified based on the correlation information. The correlation information is the information of dependencies between the model elements of the each view with one or more other views from the set of views.

At block 308, the view updating module 218 is configured to update the target view and the subset of views based on the user inputs. For example, if the user makes some changes in the target view, the subset views are automatically updated on the drawing canvas. As a result, the user does not have to manually update each view based on the changes in the target view.

At block 310, the displaying module 220 is configured to display the updated subset of views and the target view on the drawing canvas. In one embodiment, changes proposed in the target view are automatically reflected in the subset of views in real-time.

Although implementations for systems and methods for generating interlinked views of a semantic model over a drawing canvas has been described, it is to be understood that the appended claims are not necessarily limited to the specific features or methods described. Rather, the specific features and methods are disclosed as examples of implementations for generating interlinked views of a semantic model over a drawing canvas.

We claim:

1. A system for generating interlinked views of a semantic model over a drawing canvas, the system comprising:
a memory;
a processor coupled to the memory, wherein the processor is configured to execute programmed instructions stored in the memory for:
maintaining a set of views and correlation information over a database, wherein the set of views are generated over a drawing canvas based on user inputs, wherein each view comprises a set of model elements, and wherein the correlation information corresponds to dependencies between one or more model elements of each view, over one or more model elements of other views from the set of views;
receiving user inputs to update a target model element of a target view from the set of views;
identifying a subset of views, from the set of views, associated with the target view based on the target model element and the correlation information;
updating the target view and the subset of views based on the user inputs to update a target model element; and
displaying an updated target view and an updated subset of views over the drawing canvas thereby generating interlinked views of a semantic model.

2. The system of claim 1, wherein the set of views are associated with the semantic model for software development.

3. The system of claim 1, wherein the set of views comprise class view, sequence view, activity view, package view, State Machine view, object view, and use case view.

4. The system of claim 1, wherein the target view and the subset of views are updated in real-time.

5. A method for generating interlinked views of a semantic model over a drawing canvas, the method comprising:
maintaining, by a processor, a set of views and correlation information over a database, wherein the set of views are generated over a drawing canvas based on user inputs, wherein each view comprises a set of model elements, and wherein the correlation information corresponds to dependencies between one or more model elements of each view, over one or more model elements of other views from the set of views;
receiving, by the processor, user inputs to update a target model element of a target view from the set of views;
identifying, by the processor, a subset of views, from the set of views, associated with the target view based on the target model element and the correlation information;
updating, by the processor, the target view and the subset of views based on the user inputs to update a target model element; and
displaying, by the processor, an updated target view and an updated subset of views over the drawing canvas thereby generating interlinked views of a semantic model.

6. The method of claim 5, wherein the set of views are associated with the semantic model for software development.

7. The method of claim 5, wherein the set of views comprise class view, sequence view, activity view, package view, State Machine view, object view, and use case view.

8. The method of claim 5, wherein the target view and the subset of views are updated in real-time.

9. A computer program product having embodied thereon a computer program for generating interlinked views of a semantic model over a drawing canvas, the computer program product comprising:
a program code for maintaining a set of views and correlation information over a database, wherein the set of views are generated over a drawing canvas based on user inputs, wherein each view comprises a set of model elements, and wherein the correlation information corresponds to dependencies between one or more model elements of each view, over one or more model elements of other views from the set of views;
a program code for receiving, user inputs to update a target model element of a target view from the set of views;
a program code for identifying, a subset of views, from the set of views, associated with the target view based on the target model element and the correlation information;
a program code for updating, the target view and the subset of views based on the user inputs to update a target model element; and
a program code for displaying, an updated target view and an updated subset of views over the drawing canvas thereby generating interlinked views of a semantic model.
